(19) United States
(12) Patent Application Publication
(10) Pub. No.: US 2022/0188382 A1
(43) Pub. Date: Jun. 16, 2022

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Takamichi MIYAMOTO, Tokyo (JP)

(73) Assignee: NEC Corporation, Tokyo (JP)

(21) Appl. No.: 17/682,132

(22) Filed: Feb. 28, 2022

Related U.S. Application Data
(63) Continuation of application No. 17/266,183, filed on Feb. 5, 2021.

(51) Int. Cl. G06F 17/16; G06F 7/523; G06N 3/063

(52) U.S. Cl. CPC G06F 17/16; G06N 3/063; G06F 7/523

(57) ABSTRACT

An information processing apparatus 1 includes: a cost calculation unit 2 configured to calculate, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and a matrix processing selection unit 3 configured to make combinations of the matrix processing operations, add up the costs corresponding to the respective matrix processing operations included in each combination, and selects a combination of the matrix processing corresponding to the added-up cost that is smallest among costs added up for the respective combinations.

The present application is a Continuation application of Ser. No. 17/266,183 filed on Feb. 5, 2021, which is a National Stage Entry of PCT/JP2018/029693 filed on Aug. 7, 2018, the contents of all of which are incorporated herein by reference, in their entirety.

### TECHNICAL FIELD

The present invention relates to an information processing apparatus and an information processing method for executing convolution processing, and further relates to a computer-readable recording medium that includes a program recorded thereon for realizing the apparatus and method.

### BACKGROUND ART

In recent years, deep learning is frequently used in fields such as object recognition, speech recognition, and natural language processing. Also, it is known that, in deep learning in which an image is taken as an input, many convolutional layers are used. Therefore, it is desired to increase the speed of convolution processing to be executed on an input image in the convolutional layers, because the processing cost tends to increase in general.

As a technique for increasing the speed of the convolution processing, a method is known in which, after executing column matrix conversion processing (im2col processing) in which the column matrix of an input image (input data: matrix) is rearranged using a kernel (filter: matrix), matrix multiplication (gemm: general matrix multiplication) processing is performed. Among these, regarding the matrix multiplication processing, the speed of the convolution processing is increased by using a BLAS (Basic Linear Algebra Subprograms) library and the like that are provided by the vendor of a general-purpose central processing unit (CPU), a GPU (Graphic Processing Unit), or the like.

The reason why the speed of the matrix multiplication processing can be increased by using the BLAS library is that optimization has been performed such that the hardware can be used with high efficiency, such as effective utilization of the vector arithmetic unit of the CPU, and minimization of memory accesses.

As a related technique, a technique for increasing the speed of the matrix multiplication processing is disclosed in Non-Patent Document 1. Specifically, Non-Patent Document 1 discloses a technique in which an original matrix is decomposed into matrices of a plurality of predetermined formats, and matrix multiplication processing is performed according to the format of each of the matrices obtained by decomposition.

### LIST OF RELATED ART DOCUMENTS

### Non-Patent Document

Non-Patent Document 1: Kazushige Goto, Robert A. van de Geijn, “Anatomy of High-Performance Matrix Multiplication” ACM Transactions on Mathematical Software (TOMS) Volume 34, May 3, 2008, Article No. 12 pp.12:1-12:25, Internet <URL:https://dl.acm org/citation.cfm?id=1356053>

### SUMMARY

### Technical Problems

However, when the convolution processing is executed after performing quantization, or is executed in an environment in which the BLAS library is not provided, there are cases where the library provided by a vendor cannot be used. In such a case, a user needs to prepare a user function that is developed by the user so as to effectively use the vector arithmetic unit. In particular, the user needs to prepare a plurality of user functions (matrix multiplication processing) for each combination of two matrices that are different in parallelism.

The matrices that are different in parallelism refer to matrices, regarding two matrices that are targets, in which the number of rows is the same but the number of columns is different, or in which the number of rows of one matrix is the same as the number of columns of the other matrix, but the number of columns of the one matrix differs from the number of rows of the other matrix, or the like.

Moreover, in order to effectively use the plurality of user functions (matrix multiplication processing), the output data of column matrix conversion processing, which is preprocessing, needs to match the data structure that can be used in matrix multiplication processing, which is post-processing. Specifically, in order to effectively utilize the vector arithmetic unit (in order to effectively use memory commands to be executed in the matrix multiplication processing) in convolution processing in which the matrix multiplication processing is executed after the column matrix conversion processing, the output data of the column matrix conversion processing needs to be rearranged using translocation processing or the like. Therefore, a different user function needs to be prepared for each arrangement of the output data of the column matrix conversion processing.

Also, in the technique disclosed in Non-Patent Document 1, the matrix multiplication processing is switched according to the parameter corresponding to the format of each of the matrices obtained by decomposition. However, even if the technique disclosed in Non-Patent

Document 1 is applied to the convolution processing, the output data of the column matrix conversion processing needs to be rearranged, and processing operations that match respective matrices obtained by decomposition are needed, as described above, and therefore the processing speed of the convolution processing cannot be improved.

An example object of the invention is to provide an information processing apparatus, an information processing method, and a computer-readable recording medium that are able to improve the processing speed of convolution processing.

### Solution to the Problems

To achieve the above-stated example object, an information processing apparatus according to an example aspect of the invention includes:

a cost calculation unit configured to calculate, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

a matrix processing selection unit configured to make combinations of the matrix processing operations, add up the costs corresponding to the respective matrix processing operations included in each combination, and selects a combination of the matrix processing corresponding to the added-up cost that is smallest among costs added up for the respective combinations.

Also, to achieve the above-stated example object, an information processing method according to an example aspect of the invention includes:

calculating, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

making combinations of the matrix processing operations, adding up the costs corresponding to the respective matrix processing operations included in each combination, and selecting a combination of the matrix processing corresponding to the added-up cost that is smallest among costs added up for the respective combinations.

Furthermore, to achieve the above-stated example object, a computer-readable recording medium according to an example aspect of the invention is a computer-readable recording medium that includes a program recorded thereon, the program causing a computer to carry out:

calculating, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

making combinations of the matrix processing operations, adding up the costs corresponding to the respective matrix processing operations included in each combination, and selecting a combination of the matrix processing corresponding to the added-up cost that is smallest among costs added up for the respective combinations.

### ADVANTAGEOUS EFFECTS OF THE INVENTION

As described above, according to the invention, the processing speed of convolution processing can be improved.

### BRIEF DESCRIPTION OF THE DRAWINGS

FIG. 1 is a diagram illustrating an example of an information processing apparatus.

FIG. 2 is a diagram specifically illustrating the configuration of the information processing apparatus.

FIG. 3 is a diagram for describing cost calculation of column matrix conversion processing.

FIG. 4 is a diagram illustrating an example of cost calculation of the column matrix conversion processing.

FIG. 5 is a diagram illustrating an example of a program of matrix multiplication processing.

FIG. 6 is a diagram for describing matrix multiplication processing using a vector arithmetic unit.

FIG. 7 is a diagram for describing matrix multiplication processing using the vector arithmetic unit. FIG. 8 is a diagram illustrating an example of cost calculation of the column matrix conversion processing.

FIG. 9 is a diagram illustrating an example of a data structure of matrix processing selection information.

FIG. 10 is a diagram illustrating an example of operations of the information processing apparatus 1.

FIG. 11 is a diagram illustrating an example of operations of a cost calculation unit and a matrix processing selection unit.

FIG. 12 is a diagram illustrating an example of a computer that realizes the information processing apparatus.

### EXAMPLE EMBODIMENT

### Example Embodiment

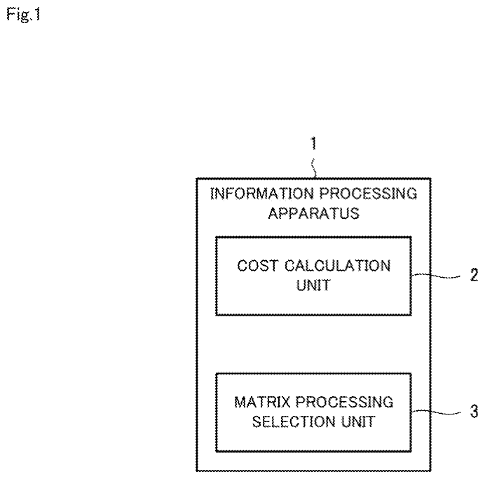

Hereinafter, an example embodiment of the invention will be described with reference to FIGS. 1 to 12.

### Apparatus Configuration

First, the configuration of an information processing apparatus according to the present example embodiment will be described using FIG. 1. FIG. 1 is a diagram illustrating an example of the information processing apparatus.

An information processing apparatus 1 according to the present example embodiment shown in FIG. 1 is an apparatus for improving the processing speed of convolution processing. As shown in FIG. 1, the information processing apparatus 1 includes a cost calculation unit 2 and a matrix processing selection unit 3.

Out of these units, the cost calculation unit 2 calculates, for each matrix processing operation to be executed in convolution processing, the cost of the matrix processing based on memory access using input data information indicating the data size of input data, kernel information indicating the data size of a kernel, and parameter information indicating a parameter to be used in the convolution processing.

The input data information is information regarding input data (input image: matrix) and the like to be input in the convolution processing. Also, target information includes at least following parameters (num, channels, height, width). These parameters indicate the number of pieces of input data by “num”, the number of channels by “channels”, the number of rows by “height”, and the number of columns by “width”.

The kernel information and the parameter information are information indicating the contents of processing to be used in the convolution processing. The information indicating the contents of processing may include following parameters: num_output, kernel_h, kernel_w, stride_h, stride_w, pad_h, and pad_w, for example. Note that the following parameters may further be included: dilation_h, dilation_w, and groups.

These parameters indicate the number of output channels by “num_output”, the number of rows of the kernel by “kernel_h”, and the number of columns of the kernel by “kernel_w”. Also, the parameters “stride_h” and “stride_w” indicate the movement amount of stride, and “pad_h” and “pad_w” indicate the size of range regarding which padding is performed. Also, “dilation_h” and “dilation_w” indicate the dilation rate in dilated convolution, and “groups” indicates the number of groups in group convolution processing.

The matrix processing is processing such as column matrix conversion processing (im2col processing), matrix multiplication processing (gemm processing), and data conversion processing (translocation processing) between the column matrix conversion processing and the matrix multiplication processing, for example.

The cost of each matrix processing operation is calculated, with respect to each of the column matrix conversion processing, the matrix multiplication processing, and the data conversion processing, using a cost calculation method based on later-described memory access (e.g., accessing to a register, a cache, a memory area (such as a data area), and the like by the CPU).

The matrix processing selection unit 3 makes combinations of the matrix processing operations, adds up the costs corresponding to the respective matrix processing operations included in each combination, and selects a combination of matrix processing corresponding to the added-up cost that is smallest among costs added up for the respective combinations.

For example, it is assumed that the combinations of matrix processing operations are a combination between a column matrix conversion processing A, matrix multiplication processing B, and data conversion processing C, and a combination between a column matrix conversion processing D, matrix multiplication processing E, and data conversion processing F. In this case, the total sum of the costs of the respective matrix processing operations A, B, and C is compared with the total sum of the costs of the respective matrix processing operations D, E, and F, and the combination of matrix processing regarding which total sum of the costs is smallest is selected.

In this way, in the present example embodiment, the combination of matrix processing regarding which the total sum of costs based on the memory access is smallest is selected, and the convolution processing is performed using the selected combination of matrix processing, and as a result, the processing speed of the convolution processing can be improved.

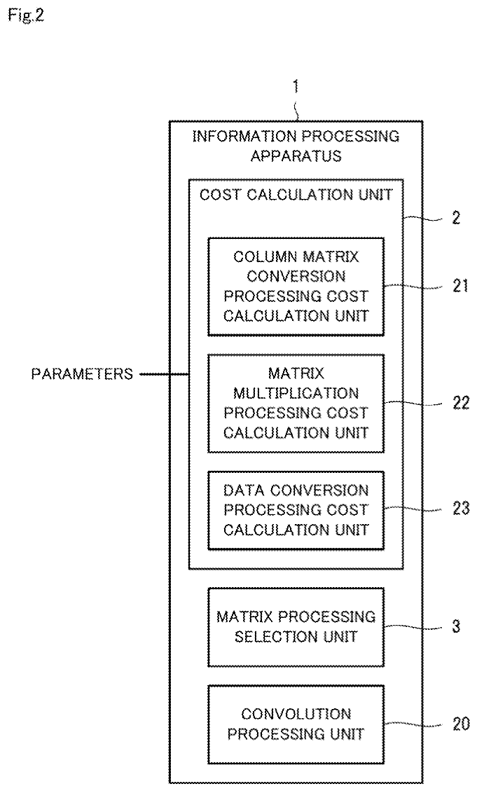

Next, the configuration of the information processing apparatus 1 according to the present example embodiment will be more specifically described using FIG. 2. FIG. 2 is a diagram specifically illustrating the configuration of the information processing apparatus.

As shown in FIG. 2, the information processing apparatus 1 according to the present example embodiment includes a convolution processing unit 20 in addition to the cost calculation unit 2 and the matrix processing selection unit 3. The convolution processing unit 20 executes the convolution processing using the combination of matrix processing selected using the cost calculation unit 2 and the matrix processing selection unit 3. That is, the convolution processing unit 20 executes the convolution processing using the combination of matrix processing with which the cost is smallest.

When the convolution processing unit 20 executes the convolution processing, the cost calculation unit 2 acquires the parameters described above, and calculates a cost based on the memory access using the acquired parameters. Also, the cost calculation unit 2 includes a column matrix conversion processing cost calculation unit 21, a matrix multiplication processing cost calculation unit 22, and a data conversion processing cost calculation unit 23.

The column matrix conversion processing cost calculation unit 21 calculates costs of one or more types of column matrix conversion processing based on the memory access using the acquired parameters. Specifically, first, the column matrix conversion processing cost calculation unit 21 calculates a number of elements and the number of copies regarding the number of elements with respect to copying of one or more continuous elements on the memory and copying of one or more continuous constant values on the memory, separately.

That is, the column matrix conversion processing cost calculation unit 21 calculates, with respect to copying of one or more continuous elements on the memory, the number of elements, which is at least one, that are continuous on the memory and the number of copies regarding the number of elements. Also, the column matrix conversion processing cost calculation unit 21 calculates, with respect to copying of values when a constant value is copied to the output data, the number of elements, which is at least one, that are continuous on the memory, and the number of copies regarding the number of elements.

Next, the column matrix conversion processing cost calculation unit 21 calculates a value obtained by multiplying the calculated number of copies regarding the number of elements and a cost setting value regarding copying that is set according to the number of continuous elements, as the cost. Also, the column matrix conversion processing cost calculation unit 21 calculates a value obtained by multiplying the calculated number of copies of constant values regarding the number of elements and a cost setting value regarding copying of constant values that is set according to the number of continuous elements, as the cost. Thereafter, the column matrix conversion processing cost calculation unit 21 calculates the sum of the costs described above, which serves as the total sum of costs of the column matrix conversion processing.

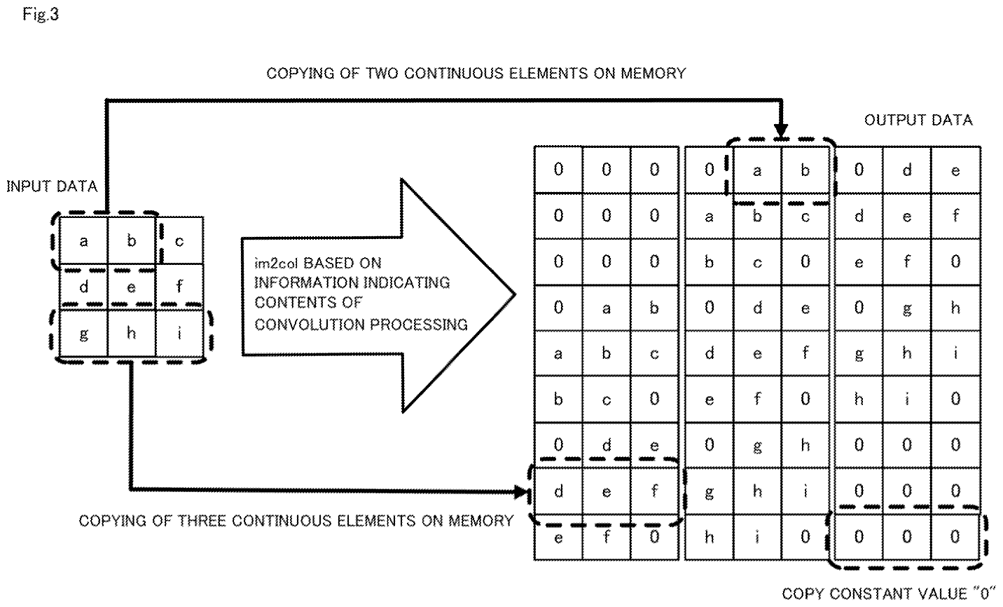

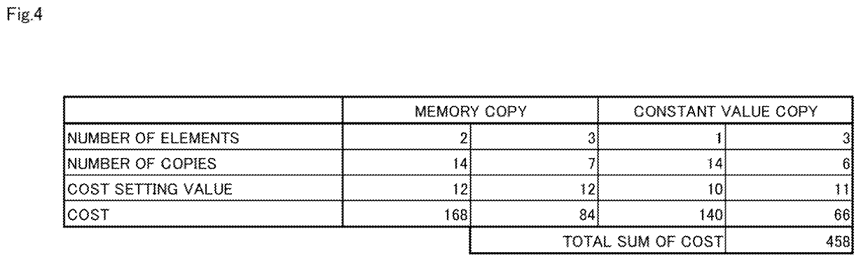

FIG. 3 is for describing the cost calculation of the column matrix conversion processing in further detail using FIG. 4. FIG. 3 is a diagram for describing the cost calculation of the column matrix conversion processing. FIG. 4 is a diagram illustrating an example of the cost calculation of the column matrix conversion processing.

FIG. 3 shows an example in which output data is calculated by performing column matrix conversion processing on 3×3 input data that is constituted by elements (a, b, c, d, e, f, g, h, and i). Also, in FIG. 3, the arrow from the elements a and b (inside a broken line) of the input data to elements a and b (inside a broken line) of the output data indicates copying of two continuous elements, on the memory. Also, the arrow from the elements g, h, and i (inside a broken line) of the input data to elements g, h, and i (inside a broken line) of the output data indicates copying of three continuous elements, on the memory. Moreover, in FIG. 3, constant values “0” inside a broken line in the output data indicates that a constant value “0” is copied to three elements.

A method of sorting between copying of one or more continuous elements on the memory (memory copy) and copying of a certain constant value to one or more areas on the memory (constant value copy), when 9×9 output data is generated from 3×3 input data, will be described using FIG. 3. In the example in FIG. 3, the input data information, which is the target, is assumed to be num=1, channels=1, height=3, and width=3.

Also, the information indicating the contents of processing to be used in the convolution processing (kernel information, parameter information) is assumed to be num_output=1, kernel_h=3, kernel_w=3, stride_h=1, stride_w=1, pad_h=1, pad_w=1, dilation_h=1, dilation_w=1, and groups=1.

In the first row of the output data, sorting is performed into copying of a constant value 0 to [0][0:2] (constant value copy of 3 elements), copying of a constant value 0 to [0][3] (constant value copy of 1 element), copying of input data [0][0:1] to output data [0][4:5] (memory copy of 2 elements), copying of a constant value 0 to [0] [6] (constant value copy of 1 element), and copying of input data [1][0:1] to output data [0][7:8] (memory copy of 2 elements).

In the second row of the output data, sorting is performed into copying of a constant value 0 to [1][0:2] (constant value copy of 3 elements), copying of input data [0][0:2] to output data [3:5] (memory copy of 3 elements), and copying of input data [1][0:2] to output data [1][6:8] (memory copy of 3 elements).

In the third row of the output data, sorting is performed into copying of a constant value 0 to [2][0:2] (constant value copy of 3 elements), copying of input data [0] [1:2] to output data

[3:4] (memory copy of 2 elements), copying of a constant value 0 to [2][5] (constant value copy of 1 element), copying of input data [1][1:2] to output data [2][6:7] (memory copy of 2 elements), and copying of a constant value 0 to [2][8] (constant value copy of 1 element).

In the fourth row of the output data, sorting is performed into copying of a constant value 0 to [3][0] (constant value copy of 1 element), copying of input data [0][0:1] to output data [3][1:2] (memory copy of 2 elements), copying of a constant value 0 to [3][3] (constant value copy of 1 element), copying of input data [1][0:1] to output data [3][4:5] (memory copy of 2 elements), copying of a constant value 0 to [3][6] (constant value copy of 1 element), and copying of input data [2][0:1] to output data [3][7:8] (memory copy of 2 elements).

In the fifth row of the output data, sorting is performed into copying of input data [0][0:2] to output data [4][0:2] (memory copy of 3 elements), copying of input data [1][0:2] to output data [3:5] (memory copy of 3 elements), copying of input data [2][0:2] to output data [4][6:8] (memory copy of 3 elements).

In the sixth row of the output data, sorting is performed into copying of input data [0][1:2] to output data [5][0:1] (memory copy of 2 elements), copying of a constant value 0 to [5][2] (constant value copy of 1 element), copying of input data [1][1:2] to output data [5][3:4] (memory copy of 2 elements), copying of a constant value 0 to [5][5] (constant value copy of 1 element), copying of input data [2][1:2] to output data [5][6:7] (memory copy of 2 elements), copying of a constant value 0 to [5][8] (constant value copy of 1 element).

In the seventh row of the output data, sorting is performed into copying of a constant value 0 to [6][0] (constant value copy of 1 element), copying of input data [1][0:1] to output data [1:2] (memory copy of 2 elements), copying of a constant value 0 to [6][3] (constant value copy of 1 element), copying of input data [2][0:1] to output data [6][4:5] (memory copy of 2 elements), copying of a constant value 0 to [6][6:8] (constant value copy of 3 elements).

In the eighth row of the output data, sorting is performed into copying of input data [0:2] to output data [7][0:2] (memory copy of 3 elements), copying of input data [2][0:2] to output data [7][3:5] (memory copy of 3 elements), copying of a constant value 0 to [7][6:8] (constant value copy of 3 elements).

In the ninth row of the output data, sorting is performed into copying of input data [1][1:2] to output data [8][0:1] (memory copy of 3 elements), copying of a constant value 0 to [8][2] (constant value copy of 1 element), copying of input data [2][1:2] to output data [8][3:4] (memory copy of 3 elements), copying of a constant value 0 to [8][5] (constant value copy of 1 element), copying of a constant value 0 to [8][6:8] (constant value copy of 3 elements).

The cost calculation with respect to the example in FIG. 3 will be described using FIG. 4. With respect to the example in FIG. 3, the number of memory copies regarding the number of elements 2 is 14, the number of memory copies regarding the number of elements 3 is 7, the number of constant value copies regarding the number of elements 1 is 14, and the number of constant value copies regarding the number of elements 3 is 6.

When the cost setting value of the memory copy regarding the number of elements 2 per time is assumed to be 12, the cost is 168. When the cost setting value of the memory copy regarding the number of elements 3 per time is assumed to be 12, the cost is 84. When the cost setting value of the constant value copy regarding the number of elements 1 per time is assumed to be 10, the cost is 140. When the cost setting value of the constant value copy regarding the number of elements 3 per time is assumed to be 11, the cost is 66. Therefore, the total sum of cost at this time is 458. Note that the cost setting values are values to be used when calculating the cost, and are values that are calculated based on an experiment, a simulation, and the like, in advance.

The matrix multiplication processing cost calculation unit 22 calculates the matrix size using the acquired parameters, and calculates the costs of one or more types of matrix multiplication processing based on the memory access. Specifically, first the matrix multiplication processing cost calculation unit 22 calculates the number of multiplications according to the parallelism to be used, and the number of additions according to the parallelism to be used.

Next, the matrix multiplication processing cost calculation unit 22 calculates costs by multiplying the calculated number of multiplications and number of additions by the respective cost setting values per command to the memory. Thereafter, the matrix multiplication processing cost calculation unit 22 calculates the sum of the aforementioned costs, and regards this sum as the total sum of costs of the matrix multiplication processing.

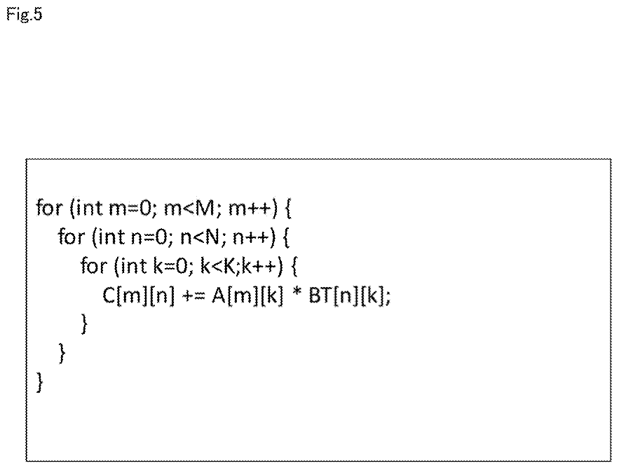

The cost calculation of the matrix multiplication processing will be described in more detail using FIGS. 5 to 8. FIG. 5 is a diagram illustrating an example of the program of matrix multiplication processing. The program in FIG. 5 shows a program of matrix multiplication for calculating a matrix C[M][N] of 32-bit integer using a matrix A[M][K] of 6-bit integer and a matrix B[K][N] of 6-bit integer. Also, the program in FIG. 5 shows a program in general for obtaining a matrix BT[N][K] by translocating a matrix B[K][N] without using a vector arithmetic unit. Note that, in the program in FIG. 5, it is assumed that M is 32, N is 100, and K is 288.

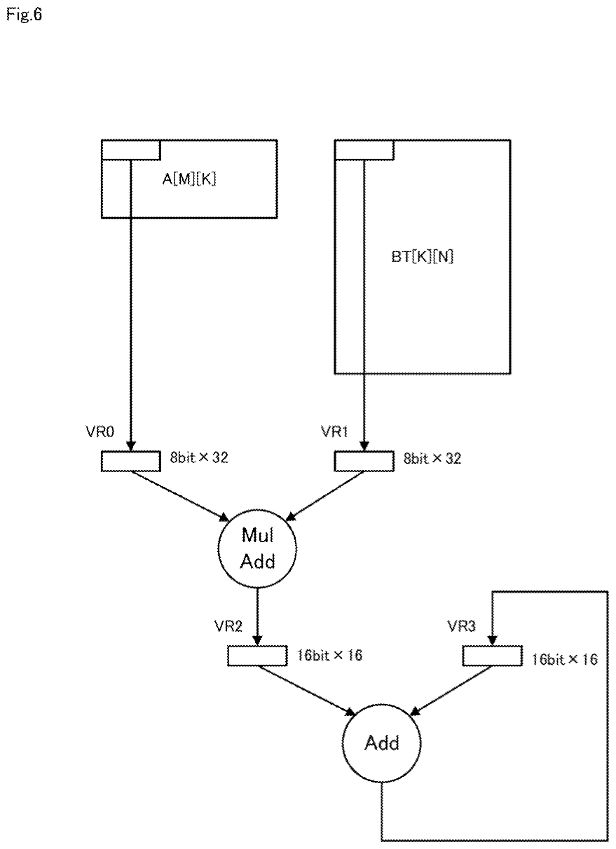

FIG. 6 is a diagram for describing matrix multiplication processing using the vector arithmetic unit. FIG. 6 shows an operation image when the vector arithmetic unit is used with respect to the loop in a K direction of the program shown in FIG. 5. Also, it is assumed that the vector length of the vector arithmetic unit is 256 bits in the example in FIG. 6.

First, K direction data in the matrix A is read into a vector register. Because the data is read into the 256-bit vector register, 32 pieces of 8-bit data are collectively read into a vector register 0 (VR0). Also, K direction data of the matrix BT is read into the vector register. Since the data is read into the 256-bit vector register, 32 pieces of 8-bit data are collectively read into a vector register 1 (VR1).

With respect to the vector register 0 (expressed as VR0[32][8]) whose data arrangement is [32][8] and the vector register 1 (expressed as VR1[32][8]) whose data arrangement is [32][8], multiplication of 8-bit data of same positions such as VR0[0][8] and VR1[0][8], and VR0[1][8] and VR1[1][8] is performed, addition of the multiplication results is performed such that the result of multiplication between VR0[0][8] and VR1[0][8] is added to the result of multiplication between VR0[1][8] and VR1[1][8], and the result of addition is written into VR2[0][16] of a vector register 2 (VR2[16][16]) of 16 pieces of 16-bit data.

Next, the result stored in the vector register 2 (VR2) that is calculated by the aforementioned multiplication and addition is repeatedly added to the result stored in a vector register 3 (VR3[16][16]) to be used for calculating the total sum. In this way, the total sum of multiplications in the K direction other than a remainder when divided by 32 is written into the vector register 3 (VR3) as divided 16 total sums.

Incidentally, in order to avoid the overflow in the 16-bit vector register 3 (VR3) according to the numbers of bits of the matrix A and the matrix B, the result that has been held in 16 bits needs to be held in 32 bits. Therefore, according to the sum of the numbers of bits of data of the matrix A and the matrix B, conversion to 32 bits is performed every time 16-bit addition is performed a certain number of times.

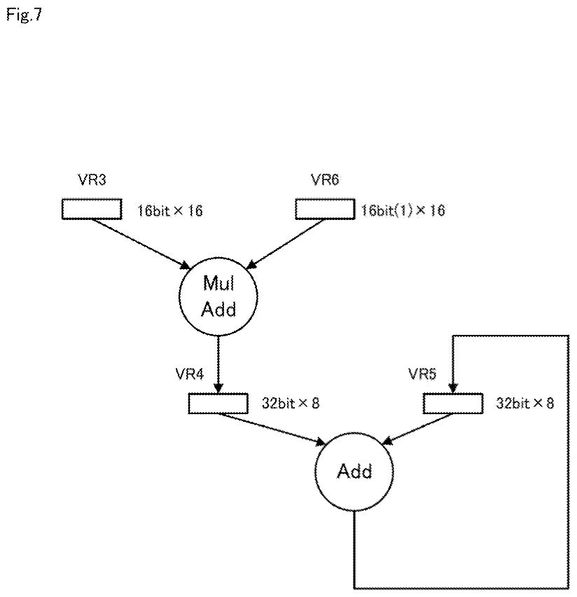

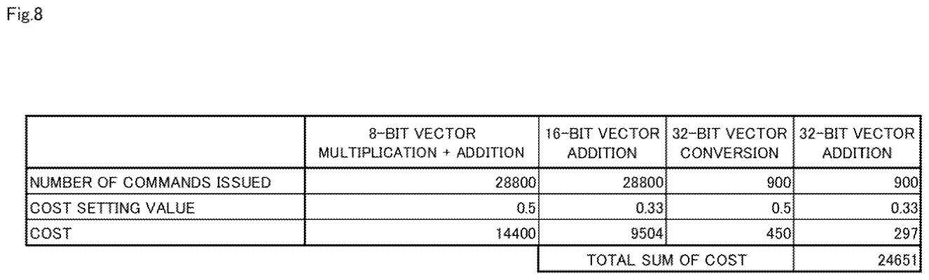

FIG. 7 is a diagram for describing matrix multiplication processing using the vector arithmetic unit. FIG. 7 shows an operation image of conversion to 32 bits in order to avoid the overflow in 16 bits.

In the example in FIG. 7, since both of the matrix A and the matrix B are 6-bit integer matrices, 13-bit data is obtained by adding multiplication result of 12 bits, which is the largest depending on the multiplication, and an adjacent element. Therefore, 16-bit temporal total sum can be calculated until 32 times of additions at the maximum. Therefore, conversion to 32 bits is performed once per 32 times, and the result is written in a 32-bit register.

For example, in order to add VR3[0][16] and VR3[1][16] of the vector register 3 (VR3[16][16]) and write the result of addition to VR4[0][32] of a VR4[8][32] whose data size is 8 pieces of 32-bit data, VR3[16][16] is multiplied by a 16-bit vector register 6 (VR6) of 16 pieces of value “1”.

Also, as a result of performing vector addition between the aforementioned result of multiplication and the result stored in a vector register (VR5[32][8]) to be used for calculating the total sum, the total sum of the multiplication in the K direction is obtained as divided eight results of total sum.

Finally, the total sum other than the remainder when divided by 32 is calculated by adding the divided eight results of total sum. The total sum of multiplications in the K direction is calculated by adding, regarding the remainder part when divided by 32, a multiplication result per element without using vector operation to the total sum other than the remainder.

FIG. 8 is a diagram illustrating an example of the cost calculation of the column matrix conversion processing. FIG. 8 shows the cost when the vector arithmetic unit is used with respect to a K direction loop when M is 32, N is 100, and K is 288.

In FIG. 8, 8-bit multiplication+addition command is performed K/32 times and M×N times in the K direction, and therefore the number of commands issued is expressed as M×N×(K/32) times. Therefore, regarding the command, the number of commands issued is 28800 (=32×100×(288/32)). Also, when the cost setting value per time is 0.5, the cost is 14400.

The cost setting value is a value to be used when calculating the cost, and is a value calculated based on an experiment, a simulation, or the like, in advance.

Also, in FIG. 8, a 16-bit addition command is issued K/32 times and M×N times in the K direction, and therefore the number of commands issued is expressed as M×N×(K/32) times. Therefore, regarding the command, the number of commands issued is 28800 (=32×100×(288/32)). Also, when the cost setting value per time is 0.33, the cost is 9504.

Also, the number of 32-bit vector conversion command to be issued is, because the 16-bit multiplication+addition command are issued K/32/32 times and M×N times (or at least once) in the K direction, expressed as M×N×(K/32/32) times. Therefore, regarding the conversion, the number of command issued is 900 (=32×100 (288/32/32)). Also, when the cost setting value per time is 0.5, the cost is 450.

Also, in a 32-bit vector addition command, because the 16-bit multiplication+addition commands are issued K/32/32 times and M×N times (or at least once) in the K direction, the number is expressed as M×N×(K/32/32) times. Therefore, regarding the conversion, the number of command issued is 900 (=32×100×(288/32/32)). Also, when the cost setting value per time is 0.33, the cost is 297.

The data conversion processing cost calculation unit 23 determines whether or not the data conversion processing is needed using the data structure of output data (matrix) output from the column matrix conversion processing and the data structure of data that can be input to the matrix multiplication processing. If the data conversion processing is needed, the data conversion processing cost is calculated based on the memory access. If the data conversion processing is not needed, the data conversion processing cost is not calculated.

Specifically, the data conversion processing cost calculation unit 23, if the data conversion processing is needed in all combinations between the column matrix conversion processing and the matrix multiplication processing, converts the data structure of the output data output from the column matrix conversion processing to the data structure that can be applied to the matrix multiplication processing.

Translocation processing is one data conversion processing handled by the data conversion processing cost calculation unit 23. The translocation processing of A×B matrix can be defined as the memory copy of one element being performed A×B times. When the cost setting value of the memory copy of one element is 12, the cost of data conversion is calculated as A×B×12. When the output data of im2col shown in FIG. 3 is translocated, the data conversion processing cost calculation unit 23 calculates the cost as 9'9×12=972.

The matrix processing selection unit 3 acquires the cost of each matrix processing operation (cost of each column matrix conversion processing (im2col processing), cost of each matrix multiplication processing operation (gemm processing), and data conversion cost (e.g., translocation processing)), and selects the combination of matrix processing with which the cost is smallest among the combinations of matrix processing. Also, the matrix processing selection unit 3 instructs the convolution processing unit 20 to perform the convolution processing using the matrix processing included in the combination with which the cost is smallest.

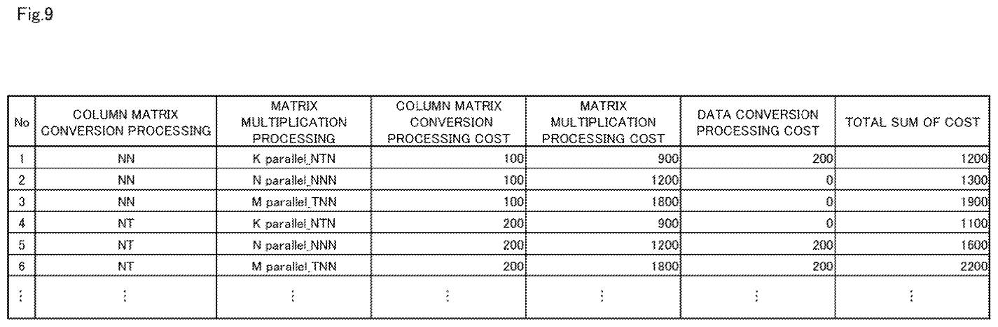

Specific description will be given using FIG. 9. FIG. 9 is a diagram illustrating an example of the data structure of matrix processing selection information. In the matrix processing selection information in FIG. 9, six types of combinations are shown with respect to two types (NN, NT) of column matrix conversion processing and three types (K parallel_NTN, N parallel_NNN, M parallel_TNN) of matrix multiplication processing as the user function. Also, the total sum of the column matrix conversion processing cost, the matrix multiplication processing cost, and the data conversion processing cost is shown in the matrix processing selection information with respect to six types of combinations.

The type NN of the column matrix conversion processing is im2col processing for reconstructing input data information (channels×(Height×Width)) to channels×kernel_h×kernel_w×(outHeight×outWidth).

The type NT of the column matrix conversion processing is im2col processing for reconstructing input data information (channels×(Height×Width)) to (outHeight×outWidth)×kernel_h×kernel_w×channels.

The type K parallel_NTN of the matrix multiplication processing indicates the matrix multiplication using parallelism in the K direction, the type K parallel_NNN indicates matrix multiplication utilizing parallelism in an N direction, and the type M parallel_TNN indicates matrix multiplication utilizing parallelism in an M direction.

The column matrix conversion processing cost indicates the cost of each of the types NN and NT of the column matrix conversion processing. The matrix multiplication processing cost indicates the cost of each of the types K parallel_NTN, K parallel_NNN, and M parallel_TNN of the matrix multiplication processing. The data conversion processing cost indicates the cost needed to perform conversion on output data of the column matrix conversion processing, in the six types of combinations.

For example, in the case of FIG. 9, the matrix processing selection unit 3 selects the combination corresponding to the smallest total sum of cost of 1100. That is, the matrix processing selection unit 3 selects the type NT of the column matrix conversion processing and the type K parallel_NTN of the matrix multiplication processing.

### Apparatus Operations

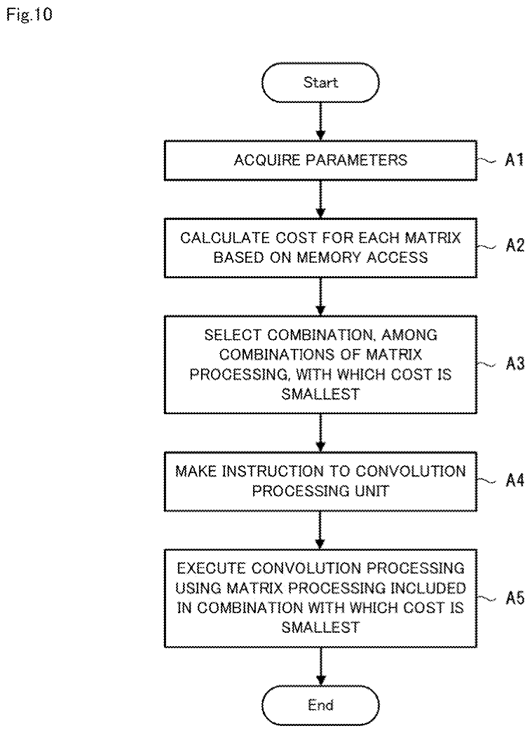

Next, the operations of the information processing apparatus 1 according to the example embodiment of the invention will be described using FIG. 10. FIG. 10 is a diagram illustrating an example of the operations of the information processing apparatus. In the following description, FIGS. 2 to 9 will be referred to as appropriate. Furthermore, in the present example embodiment, the information processing method is carried out by causing the information processing apparatus 1 to operate. Therefore, the following description of the operations of the information processing apparatus 1 applies to the information processing method according to the present example embodiment.

The information processing apparatus 1 acquires parameters (step A1). Next, the information processing apparatus 1 calculates the cost of each of the matrix processing (column matrix conversion processing (im2col processing), the matrix multiplication processing (gemm processing), and the data conversion cost (e.g., translocation processing)) based on the memory access using the acquired parameters (step A2). Next, the information processing apparatus 1 acquires the cost of each matrix processing operation (cost of each column matrix conversion processing operation (im2col processing), cost of each matrix multiplication processing operation (gemm processing), and data conversion cost (e.g., translocation processing)), and selects the combination of matrix processing with which the cost is smallest among the combinations of matrix processing (step A3). Next, the information processing apparatus 1 outputs an instruction for causing the convolution processing unit 20 to perform convolution processing using the matrix processing included in the combination with which the cost is smallest (step A4). Then, the information processing apparatus 1 executes the convolution processing using the matrix processing included in the combination with which the cost is smallest (step A5).

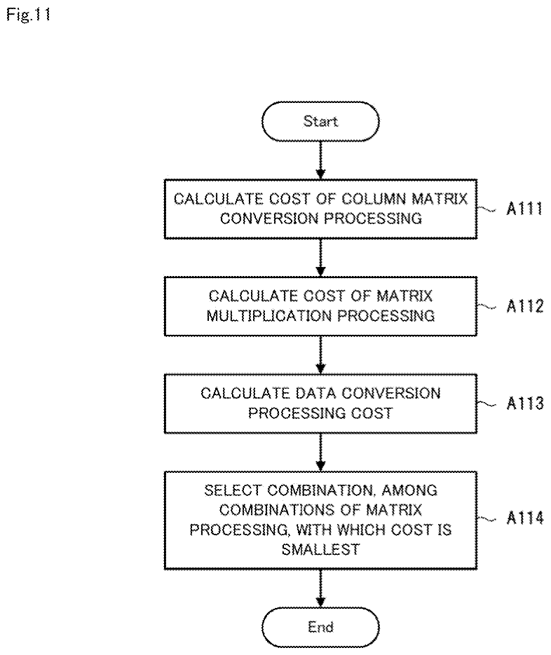

Next, steps A2 and A3 shown in FIG. 10 will be described in detail using FIG. 11. FIG. 11 is a diagram illustrating an example of the operations of the cost calculation unit and the matrix processing selection unit.

In step A111, the column matrix conversion processing cost calculation unit 21 calculates cost regarding one or more types of column matrix conversion processing based on the memory access using the acquired parameters.

Specifically, first, the column matrix conversion processing cost calculation unit 21 calculates the number of elements and the number of copies regarding the number of elements for each of copying of one or more continuous elements on the memory and copying of one or more continuous constant values on the memory.

That is, the column matrix conversion processing cost calculation unit 21 calculates the number of elements, which is at least one, that are continuous on the memory and the number of copies regarding the number of elements. Also, the column matrix conversion processing cost calculation unit 21 calculates, with respect to copying of values when a constant value is copied to the output data, the number of elements, which is at least one, that are continuous on the memory and the number of copies regarding the number of elements.

Next, the column matrix conversion processing cost calculation unit 21 calculates the cost by multiplying the calculated number of copies regarding the number of elements and the cost setting value regarding the copy that is set according to the number of continuous elements. Also, the column matrix conversion processing cost calculation unit 21 calculates the cost by multiplying the calculated number of copies of the constant values regarding the number of elements and the cost setting value regarding copying of constant values that is set according to the number of continuous elements.

Thereafter, the column matrix conversion processing cost calculation unit 21 calculates the sum of the aforementioned costs (total sum of cost of the column matrix conversion processing).

In step A112, the matrix multiplication processing cost calculation unit 22 calculates the matrix size using the acquired parameters, and calculates the cost of one or more types of matrix multiplication processing based on the memory access.

Specifically, first, the matrix multiplication processing cost calculation unit 22 calculates the number of multiplications according to the parallelism to be used and the number of additions according to the parallelism to be used.

Next, the matrix multiplication processing cost calculation unit 22 calculates the cost by multiplying the calculated number of multiplications and number of additions by the respective cost setting values per command to the memory. Thereafter, the matrix multiplication processing cost calculation unit 22 calculates the sum of aforementioned costs (total sum of cost of the matrix multiplication processing).

In step A113, the data conversion processing cost calculation unit 23 determines whether or not the data conversion processing is needed using the data structure of output data (matrix) output from the column matrix conversion processing and the data structure of data that can be input to the matrix multiplication processing. Next, if the data conversion processing is needed, the data conversion processing cost is calculated based on the memory access. If the data conversion processing is not needed, the data conversion processing cost is not calculated.

Specifically, the data conversion processing cost calculation unit 23, if the data conversion processing is needed in all combinations between the column matrix conversion processing and the matrix multiplication processing, converts the data structure of the output data output from the column matrix conversion processing to the data structure that can be applied to the matrix multiplication processing.

In step A114, the matrix processing selection unit 3 acquires the cost of each matrix processing operation (cost for each column matrix conversion processing (im2col processing), cost for each matrix multiplication processing operation (gemm processing), and data conversion cost (e.g., translocation processing)), and selects the combination of matrix processing with which the cost is smallest among the combinations of matrix processing.

### Effects According to Present Example Embodiment

As described above, according to the present example embodiment, the combination of matrix processing with which the sum of cost based on the memory access is smallest is selected, and the convolution processing is performed using the selected combination of matrix processing, and therefore the processing speed of the convolution processing can be improved.

### Program

A program according to the example embodiment of the invention need only be a program for causing a computer to perform steps A1 to A5 shown in FIG. 10 and steps A111 to A114 shown in FIG. 11. The information processing apparatus and the information processing method according to the present example embodiment can be realized by installing this program on a computer and executing the program. In this case, a processor of the computer functions as the cost calculation unit 2 (column matrix conversion processing cost calculation unit 21, the matrix multiplication processing cost calculation unit 22, the data conversion processing cost calculation unit 23), the matrix processing selection unit 3, and the convolution processing unit 20, and performs processing.

Also, the program according to the present example embodiment may also be executed by a computer system that includes a plurality of computers. In this case, for example, each of the computers may function as any of the cost calculation unit 2 (column matrix conversion processing cost calculation unit 21, the matrix multiplication processing cost calculation unit 22, the data conversion processing cost calculation unit 23), the matrix processing selection unit 3, and the convolution processing unit 20.

### Physical Configuration

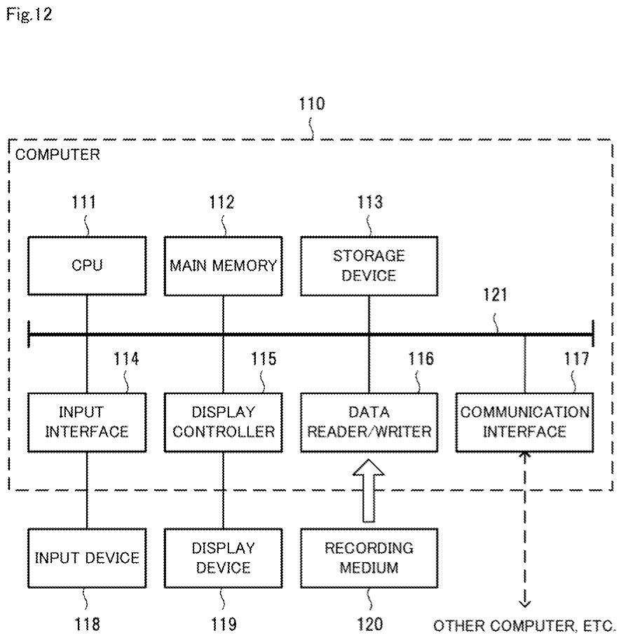

A description will now be given, with reference to FIG. 12, of a computer that realizes the information processing apparatus by executing the program according to the present example embodiment. FIG. 12 is a diagram illustrating an example of a computer that realizes the information processing apparatus.

As shown in FIG. 12, a computer 110 includes a CPU 111, a main memory 112, a storage device 113, an input interface 114, a display controller 115, a data reader/writer 116, and a communication interface 117. These units are connected to each other via a bus 121 so as to be able to communicate data. Note that the computer 110 may also include, in addition to the CPU 111 or in place of the CPU 111, a GPU (Graphics Processing Unit), or an FPGA (Field-Programmable Gate Array).

The CPU 111 loads the program (codes) according to the present example embodiment that is stored in the storage device 113 to the main memory 112 and executes the program in a predetermined order, thereby performing various kinds of computation. The main memory 112 is typically a volatile storage device such as a DRAM (Dynamic Random Access Memory). The program according to the present example embodiment is provided in a state of being stored in a computer-readable recording medium 120. Note that the program according to the present example embodiment may also be distributed on the Internet to which the computer is connected via the communication interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display in the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

### Supplementary Note

In relation to the above example embodiment, the following Supplementary Notes are further disclosed. Part of, or the entire present example embodiment described above can be expressed by the following (Supplementary note 1) to (Supplementary note 12), but is not limited thereto.

### Supplementary Note 1

An information processing apparatus including:

a cost calculation unit configured to calculate, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

a matrix processing selection unit configured to make combinations of the matrix processing operations, add up the costs corresponding to the respective matrix processing operations included in each combination, and selects a combination of the matrix processing corresponding to the added-up cost that is smallest among costs added up for the respective combinations.

### Supplementary Note 2

The information processing apparatus according to supplementary note 1, wherein the cost calculation unit calculates the cost of column matrix conversion processing based on memory access in the column matrix conversion processing.

### Supplementary Note 3

The information processing apparatus according to supplementary note 2, wherein the cost calculation unit calculates the cost of matrix multiplication processing based on memory access in the matrix multiplication processing.

### Supplementary Note 4

The information processing apparatus according to supplementary note 3, wherein the cost calculation unit calculates the cost of data conversion processing for converting output data of the column matrix conversion processing based on memory access in the data conversion processing.

### Supplementary Note 5

An information processing method including:

(a) a step of calculating, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

(b) a step of making combinations of the matrix processing operations, adding up the costs corresponding to the respective matrix processing operations included in each combination, and selecting a combination of the matrix processing corresponding to the added-up cost that is smallest among costs added up for the respective combinations.

### Supplementary Note 6

The information processing method according to supplementary note 5,

wherein, in the (a) step, the cost of column matrix conversion processing is calculated based on memory access in the column matrix conversion processing.

### Supplementary Note 7

The information processing method according to supplementary note 6,

wherein, in the (a) step, the cost of matrix multiplication processing is calculated based on memory access in the matrix multiplication processing.

### Supplementary Note 8

The information processing method according to supplementary note 7,

wherein, in the (a) step, the cost of data conversion processing for converting output data of the column matrix conversion processing is calculated based on memory access in the data conversion processing.

### Supplementary Note 9

A computer-readable recording medium that includes a program recorded thereon, the program causing a computer to carry out:

(a) a step of calculating, using input data information indicating a data size of input data, kernel information indicating a data size of a kernel, and parameter information indicating a parameter to be used in convolution processing, for each matrix processing operation to be executed in the convolution processing, a cost of the matrix processing based on memory access; and

(b) a step of making combinations of the matrix processing operations, adding up the costs corresponding to the respective matrix processing operations included in each combination, and selecting a combination of the matrix processing corresponding to the added-up cost that is smallest among costs added up for the respective combinations.

### Supplementary Note 10

The computer readable recording medium that includes the program according to supplementary note 9 recorded thereon,

wherein, in the (a) step, the cost of column matrix conversion processing is calculated based on memory access in the column matrix conversion processing

### Supplementary Note 11

The computer readable recording medium that includes the program according to supplementary note 10 recorded thereon,

wherein, in the (a) step, the cost of matrix multiplication processing is calculated based on memory access in the matrix multiplication processing.

### Supplementary Note 12

The computer readable recording medium that includes the program according to supplementary note 11 recorded thereon,

wherein, in the (a) step, the cost of data conversion processing for converting output data of the column matrix conversion processing is calculated based on memory access in the data conversion processing.

The invention of the present application has been described above with reference to the present example embodiment, but the invention of the present application is not limited to the above present example embodiment. The configurations and the details of the invention of the present application may be changed in various manners that can be understood by a person skilled in the art within the scope of the invention of the present application.

### INDUSTRIAL APPLICABILITY

As described above, according to the invention, the processing speed of the convolution processing can be improved. The invention is useful in the field in which deep learning in which a convolutional layer is used is needed. For example, the invention is useful in fields such as object recognition, speech recognition, natural language processing, and biometrics authentication.

### LIST OF REFERENCE SIGNS

1 Information processing apparatus

2 Cost calculation unit

3 Matrix processing selection unit

20 Convolution processing unit

21 Column matrix conversion processing cost calculation unit

22 Matrix multiplication processing cost calculation unit

23 Data conversion processing cost calculation unit

110 Computer

111 CPU

112 Main memory

113 Storage device

114 Input interface

115 Display controller

116 Data reader/writer

117 Communication interface

118 Input devices

119 Display device

120 Recording medium

121 Bus

1. An information processing apparatus comprising:
at least one memory configured to store instructions; and
at least one processor configured to execute the instructions to:
acquire input data information indicating a data size of input data, kernel information indicating a data size of a kernel, and parameter information indicating a parameter to be used in convolution processing; and
calculate a cost of a data conversion processing based on memory access, when executing the data conversion processing between a column matrix conversion processing and a matrix multiplication processing in the convolution process executed by using the input data information, the kernel information, and the parameter information.

2. The information processing apparatus according to claim 1,
wherein, in the cost of a data conversion processing,
combine between the column matrix conversion processing and the matrix multiplication processing, and
if the data conversion processing is required, convert the data structure of the output data output from the column matrix conversion processing to the data structure that can be applied to the matrix multiplication processing.

3. The information processing apparatus according to claim 2,
wherein combine one or more the data conversion processing, one or more of the column matrix conversion processing and one or more the matrix multiplication processing to be performed in the convolution processing,
for each combination, sum the cost of the data conversion processing, a cost of the column matrix conversion processing and a cost of the matrix multiplication processing, and select a combination corresponding to a summed cost that is the smallest among the summed costs for each combination.

4. An information processing method comprising:
acquiring input data information indicating a data size of input data, kernel information indicating a data size of a kernel, and parameter information indicating a parameter to be used in convolution processing; and
calculating a cost of a data conversion processing based on memory access, when executing the data conversion processing between a column matrix conversion processing and a matrix multiplication processing in the convolution process executed by using the input data information, the kernel information, and the parameter information.

5. The information processing method according to claim 4,
wherein, in the calculating,
combining between the column matrix conversion processing and the matrix multiplication processing, and
if the data conversion processing is required, converting the data structure of the output data output from the column matrix conversion processing to the data structure that can be applied to the matrix multiplication processing.

6. The information processing method according to claim 5,
wherein combining one or more the data conversion processing, one or more of the column matrix conversion processing and one or more the matrix multiplication processing to be performed in the convolution processing,
for each combination, summing the cost of the data conversion processing, a cost of the column matrix conversion processing and a cost of the matrix multiplication processing, and
selecting a combination corresponding to a summed cost that is the smallest among the summed costs for each combination.

7. A non-transitory computer-readable recording medium that includes a program recorded thereon, the program causing a computer to carry out:
acquiring input data information indicating a data size of input data, kernel information indicating a data size of a kernel, and parameter information indicating a parameter to be used in convolution processing; and
calculating a cost of a data conversion processing based on memory access, when executing the data conversion processing between a column matrix conversion processing and a matrix multiplication processing in the convolution process executed by using the input data information, the kernel information, and the parameter information.

8. The non-transitory computer readable recording medium that includes the program according to claim 7 recorded thereon,
wherein, in the calculating,
combining between the column matrix conversion processing and the matrix multiplication processing, and
if the data conversion processing is required, converting the data structure of the output data output from the column matrix conversion processing to the data structure that can be applied to the matrix multiplication processing.

9. The non-transitory computer readable recording medium that includes the program according to claim 8 recorded thereon,
wherein combining one or more the data conversion processing, one or more of the column matrix conversion processing and one or more the matrix multiplication processing to be performed in the convolution processing,
for each combination, summing the cost of the data conversion processing, a cost of the column matrix conversion processing and a cost of the matrix multiplication processing, and
selecting a combination corresponding to a summed cost that is the smallest among the summed costs for each combination.
